(19) United States
(12) Patent Application Publication
(10) Pub. No.: US 2019/0055977 A1
(43) Pub. Date: Feb. 21, 2019

(54) RETAINING APPLIANCE FOR MECHANISM SECURING DEVICES

(71) Applicants: Herbert Ross Gingold, Longwood, FL (US); Victoria Elizabeth Gingold, Longwood, FL (US)

(72) Inventors: Herbert Ross Gingold, Longwood, FL (US); Victoria Elizabeth Gingold, Longwood, FL (US)

(21) Appl. No.: 16/105,534

(22) Filed: Aug. 20, 2018

Related U.S. Application Data
(60) Provisional application No. 62/547,918, filed on Aug. 21, 2017.

(51) Int. Cl. F16B 21/12; F16B 1/00; B60D 1/06

(52) U.S. Cl. CPC F16B 21/12; F16B 1/00; F16B 2021/14; F16B 2001/0035; B60D 1/06

(57) ABSTRACT

A retention strap for NTSB standard hitch safety pins. The retaining head has a ⅝ inch and ½-inch hole for the most common hitch pins, and ¼-inch hole for storage of a backup safety clip. The retaining head contains magnets to ensure retention of the hitch pin under most force conditions. Additionally, the magnets can retain the safety clip. The magnets also allow the device and pin to be temporarily secured to any metal surface. The large securing loop allows for multiple options for connection to the hitch or receiver.

### CROSS-REFERENCE TO RELATED APPLICATIONS

This application claims the benefit of Provisional Application No. 62/547,918 filed on Aug. 21, 2017, the contents of which are incorporated herein by reference.

### BACKGROUND OF THE INVENTION

The statements in this section merely provide background information related to the present disclosure and may not constitute prior art.

The present invention relates generally to a retention device that utilizes unique design features, dissimilar material friction and magnetic attraction to provide novel and nonintuitive benefits for the retention of securing devices.

The square hitch and receiver connection method for providing a towing ball is standardized in North America by the National Transportation Safety Board (NTSB), this convention defines various regulated standard diameters of metal pins, henceforth called safety pin, to secure the square hitch post into the vehicle mounted square receiver. There is a clip that is affixed to the safety pin, to ensure it cannot eject, henceforth called the safety clip. The hitch, receiver and safety pin and safety clip are all prior art not claimed in this patent. The safety pin is vital to the safe operation of the hitch, there is no practical or safe temporary substitute should the pin not be immediately available when needed. Additionally, the safety clip ensures the hitch pin cannot come out unintentionally is also critical to this solution.

These hitch safety pins and safety clips are both very high turnover items in the retail environment; the rate far exceeds that of new hitches, clearly indicating that many are lost.

There are many documented instances of tragic accidents where a lost hitch safety pin was temporarily substituted with a non-approved pin.

Many accidents have been attributed to the user incorrectly believing the pin was inserted, when it was in fact not inserted, or the safety clip was not affixed and the safety pin ejected.

The safety pin and safety clip are the critical components in securing the hitch into the receiver, retention of the safety pin and safety clip to the locality of the hitch and receiver is essential to improvement of safety in the common practice.

### BRIEF SUMMARY OF THE INVENTION

The presented invention is a device that retains the standard NTSB hitch pin(s) local to either the receiver or the hitch ensuring the safety pin and safety clip are always available to secure the solution. One embodiment of the present invention has a slot/ring in the strap end of the device designed to allow attachment to the hitch or receiver. The embodiment has specifically sized holes for ⅝-inch and ½-inch NTSB standard hitch safety pins in elastic material creating friction force retention. The embodiment has two magnets, in complimentary polarity, aligned parallel to the center axis of the hitch safety pin to aid in retention with magnetic attraction. The embodiment is solid red in color for visual indication that the hitch safety pin is safely inserted, and the end that holds the hitch pin and magnets is shaped in a hexagon to resemble a stop sign to provide mental stimulation to stop and check. The embodiment provides that the magnets also provide temporary storage of the safety clip, and there is also a ¼-inch hole for storage of a second, back up, safety clip.

In one embodiment the device is made of, or incorporates, metal cable material or other rigid cable like material or fiber.

In one embodiment the device has a securing mechanism to prevent unauthorized removal of the device.

In one embodiment the device is other colors such as, but not limited to black, pink, green, blue, orange, yellow, and white.

In one embodiment the device has patterns of colors such as, but not limited to college color schemes, sports team color schemes, national color schemes.

In one embodiment the device has patterns such as, but not limited to swirl, camouflage, digital patterns, natural shapes, iconic shapes.

In one embodiment the device safety pin retention end has a different shape such as, but not limited to square, round, triangular, pentagonal.

In one embodiment the device safety pin retention end has a non standard shape such as, but not limited to freeform, non-linear, non-symmetrical, and randomly impacted.

In one embodiment the device safety pin retention end has only one hole of a specific pin diameter for only one size of hitch pin.

In one embodiment the device safety pin retention end has multiple holes for multiple hitch pin sizes.

In one embodiment the device safety pin retention end has one diameter hole on one face, and a different diameter hole on the other face, sharing the same center line.

In one embodiment the device safety pin retention end has different diameter holes, offset so that they do not share the same center line.

In one embodiment the device safety pin retention end has one magnet.

In one embodiment the device safety pin retention end has multiple magnets.

In one embodiment the device has one magnet or more magnets that are parallel to the center axis of one or more safety pins.

In one embodiment the device has one magnet or more magnets that are perpendicular to the center axis of one or more safety pins.

In one embodiment the device has one magnet or more magnets that are at some common angle with respect to the center axis of one or more safety pins.

In one embodiment the device has one or more magnets that are at different angles with respect to the center axis of one or more safety pins.

### BRIEF DESCRIPTION OF THE DRAWINGS

Presently the preferred embodiments are shown in the drawings. It should be appreciated, however, that the invention is not limited to the precise arrangements and instrumentalities shown.

FIG. 1 is the top view of the device.

FIG. 2 is the side view of the device, both side views are symmetrical.

FIG. 3 is the bottom view of the device.

### DETAILED DESCRIPTION OF THE INVENTION

While the specification concludes with claims defining the features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention which can be embodied in various forms. Therefore, specific structural and functional details disclosed herein are not to be interpreted as limiting, but merely as a basis for the claims and as a representative basis for teaching one skilled in the art to variously employ the inventive arrangements in virtually any appropriately detailed structure. Further, the terms and phrases used herein are not intended to be limiting but rather to provide an understandable description of the invention.

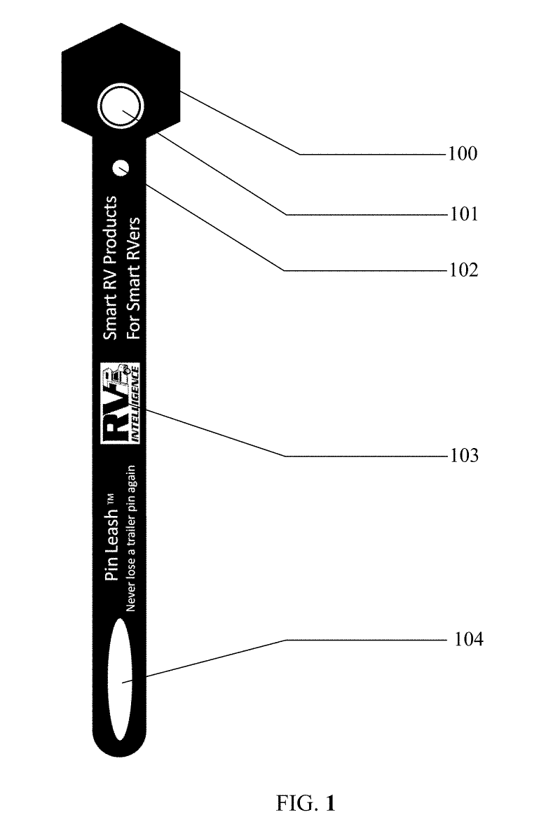

FIGS. 1-3 illustrate an embodiment of a retaining strap for connection device safety pins and safety clips that is useful for understanding the inventive concepts disclosed herein. Although the device is described for use with a National Transportation Safety Board (NTSB) regulated vehicle hitch safety pin, the invention is not limited to any particular use or industry as the invention could be utilized for any number of different purposes, in many manners of mechanical connection, in vehicles, stationary equipment or structures, retaining many types of securing mechanisms.

In FIG. 1 the device top view 100 is shown. The aperture 101 is designed to provide a friction fit for the ½-inch standard NTSB hitch safety pin. The aperture 102 is ¼-inch in diameter to provide a storage location for the safety clip used to secure the hitch safety pin. The manufacturing mold allows artwork 103 to be molded into the strap and is on a removable plate and so can be customized. There is an aperture 104 that can be looped over many points in the standard NTSB hitch structure.

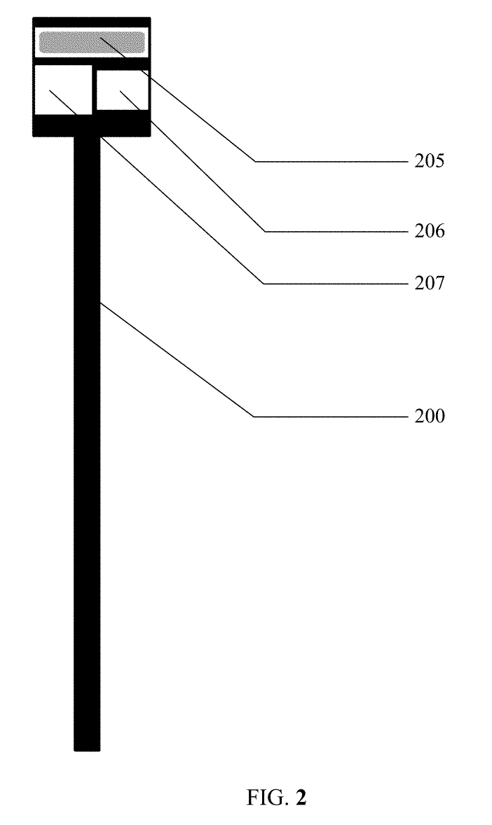

In FIG. 2 the device side view 200 is shown. Shown in cutaway view 205 is one of the two 1-inch by ⅜-inch round epoxy coated magnets in the molded enclosure design to accept the magnet. Aperture 206 is a cutaway showing the friction fit for the ½-inch standard North American hitch safety pin and the coaxial alignment with aperture 207 the friction fit for the ⅝-inch standard NTSB hitch pin.

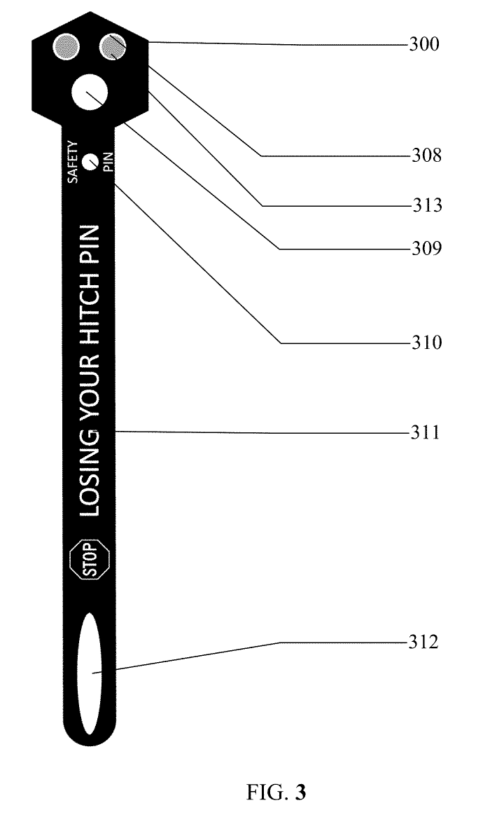

In FIG. 3 the device bottom view 300 is shown. Aperture 308 is the insertion hole for the two 1 inch by ⅜-inch round epoxy coated magnets 313 designed to provide magnetic attraction for the safety pin and safety clip. Aperture 309 is designed to provide a friction fit for the ⅝-inch standard NTSB hitch safety pin. Aperture 310 is ¼-inch in diameter to provide a storage location for the safety clip used to secure the hitch pin. The manufacturing mold allows artwork 311 to be molded into the strap and is on a removable plate and so can be customized. There is an aperture 312 that can be looped over many points in the standard NTSB hitch structure.

As to a further description of the manner and use of the present invention, the same should be apparent from the above description. Accordingly, no further discussion relating to the manner of usage and operation will be provided.

The terminology used herein is for the purpose of describing particular embodiments only and is not intended to be limiting of the invention. As used herein, the singular forms “a”, “an”, and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the present steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The claimed invention is:

1. A device that retains a securing pin or mechanism in the locality of the equipment, machine, mechanism or structure that it design to be used with:
That it has apertures that are specifically designed to provide friction fit retention for the securing pin or mechanism(s);
That it has magnet(s) in parallel, or any other potential relative angle, to the retained portion of the securing pin or mechanism to provide magnetic retention;
That with two or more magnets the orientation of the magnetic fields is complimentary in polarity;
That with two or more magnets the orientation of the magnetic fields are in opposition polarity;
That friction and magnetic attraction can be used independently or in combination;
That the retaining head is shaped to stimulate a cautious response from the user;
That the retaining head is colored to stimulate a attention response from the user.

2. A device as described in claim 1 modified to accommodate multiple sizes of securing pin or mechanism in the locality of the equipment or mechanism that it is designed to be used with:
That it has multiple apertures that are specifically designed to provide friction fit retention for the securing or safety pin(s);
That these apertures can be coaxial on opposing sides;
That these apertures can be non-coaxial on opposing sides;
That these apertures can be non-coaxial and in parallel on a common side;
That these apertures can be non-coaxial and perpendicular on orthogonal sides;
That these apertures could be used independently or simultaneously.

3. A device as described in claim 1 and claim 2 that has high strength fibers or metal cabling in embedded into all or portions of the device:
That is has a locking mechanism or capability utilizing the high strength materials.
